(19) United States
(12) Patent Application Publication
(10) Pub. No.: US 2021/0045451 A1
(43) Pub. Date: Feb. 18, 2021

(54) CIGARETTE AND AEROSOL GENERATION DEVICE FOR CIGARETTE

(71) Applicant: KT&G CORPORATION, Daejeon (KR)

(72) Inventors: Sang Won CHOI, Daejeon (KR); Dong Kyun KO, Sejong (KR); Jae Sung NOH, Cheonan-si (KR); Bong Su CHEONG, Daejeon (KR); Jung Seop HWANG, Daejeon (KR)

(73) Assignee: KT&G CORPORATION, Daejeon (KR)

(21) Appl. No.: 16/976,320

(22) PCT Filed: Nov. 13, 2019
(86) PCT No.: PCT/KR2019/015420

§ 371 Date: Aug. 27, 2020

(30) Foreign Application Priority Data
Nov. 23, 2018 (KR) 10-2018-0146423

(51) Int. Cl. A24F 40/51; A24D 1/04; A24F 40/10

(52) U.S. Cl. CPC A24F 40/51; A24F 40/10; A24D 1/045

(57) ABSTRACT

A cigarette includes a tobacco rod, a front end plug disposed at a front end of the tobacco rod, a filter rod disposed at a rear end of the tobacco rod, and an electromagnetic inducer provided in the front end plug.

### TECHNICAL FIELD

One or more exemplary embodiments of the present disclosure relate to a cigarette and an aerosol generating device for the same.

### BACKGROUND ART

Recently, the demand for alternative methods to overcome the shortcomings of traditional cigarettes has increased. For example, there is growing demand for a method of generating aerosol by heating an aerosol generating material in cigarettes, rather than by combusting cigarettes. Accordingly, studies on a heating-type cigarette and a heating-type aerosol generating device have been actively conducted.

There is a safety risk in using an aerosol generating device. For example, user's skin can be burned when a user inadvertently heats a heater while a cigarette is not inserted in the aerosol generating device due to the user's inexperience, carelessness, or the like. Therefore, in order to secure user's safety, there is a need for a method of heating the cigarette only when a cigarette is inserted in the aerosol generating device.

### DESCRIPTION OF EXEMPLARY EMBODIMENTS

### Technical Problem

The present invention provides a cigarette and an aerosol generating device in which the cigarette is inserted, wherein the aerosol generating device detects insertion of the cigarette based on electromagnetic induction. a

The problem to be solved by the present invention is not thereto. A skilled person in the art would understand that there may other problems to be solved by the present invention which are not described above from the specification and the accompanying drawings of the present disclosure.

### Solution to Problem

According to an aspect of the present disclosure, a cigarette includes: a front end plug disposed at a front end of the tobacco rod; a filter rod disposed at a rear end of the tobacco rod; and an electromagnetic inducer provided in the front end plug.

The electromagnetic inducer may be a thin film surrounding at least a portion of the front end plug.

The cigarette further includes a wrapper surrounding the front end plug, and the electromagnetic inducer may be a thin film of which one surface overlaps and faces an inner surface of the wrapper.

The cigarette includes a first wrapper surrounding the front end plug and a fifth wrapper surrounding the first wrapper, and the electromagnetic inducer may be a thin film arranged between the first wrapper and the fifth wrapper.

The electromagnetic inducer may include at least one of conductive metal, magnetic ink, and magnetic tape.

The electromagnetic inducer may also include at least one of aluminum (Al) and graphite.

A length of the electromagnetic inducer may be 6 mm or greater and less than 9 mm in a lengthwise direction of the cigarette.

The electromagnetic inducer may be a thin film having a thickness of 6 μm or greater and less than 7 μm.

Upon insertion into an aerosol generating device, the tobacco rod may be surrounded by a heater capable of heating the tobacco rod, and the front end plug may be positioned adjacent to a detector including a coil capable of detecting the electromagnetic inducer.

According to another aspect of the present disclosure, an aerosol generating device includes: a case; a heater configured to heat a cigarette including a tobacco rod, a filter rod, a front end plug disposed at a front end of the tobacco rod, and an electromagnetic inducer provided in the front end plug; a detector including a coil and configured to detect a change in characteristics of a current flowing through the coil which is generated according to electromagnetic induction caused by the electromagnetic inducer as the cigarette is inserted into the case; and a controller configured to control the heater and determine an insertion state of the cigarette based on the change in the characteristics of the current detected by the detector.

In addition, the aerosol generating device may vaporize a liquid composition to generate an aerosol, and may further include a vaporizer for delivering the aerosol to the inside of the cigarette through the front end plug.

Exemplary embodiments of the present disclosure are not limited thereto. It is to be appreciated that other exemplary embodiments will be apparent to those skilled in the art from a consideration of the specification and the accompanying drawings of the present disclosure described herein.

### Advantageous Effects of Disclosure

According to an exemplary embodiment, user safety may be secured by operating the heater while the cigarette is inserted into the aerosol generating device.

According to an exemplary embodiment, by identifying the type of the inserted cigarette and by heating a certain cigarette, the user safety may be secured and a smoking flavor may be improved.

Exemplary embodiments of the present disclosure are not limited thereto. It is to be appreciated that other exemplary embodiments will be apparent to those skilled in the art from the specification and the accompanying drawings of the present disclosure described herein.

### BRIEF DESCRIPTION OF DRAWINGS

FIG. 1 is a perspective view of a cigarette according to an exemplary embodiment of the present disclosure.

FIG. 2 is a perspective view of a cigarette according to another exemplary embodiment of the present disclosure.

FIGS. 3 and 4 are block diagrams illustrating exemplary embodiments of an aerosol generating device.

FIG. 5 is a diagram of an aerosol generating device into which a cigarette is inserted.

FIG. 6 is a graph of characteristics of a current detected by an aerosol generating device according to an insertion state of a cigarette.

### BEST MODE

According to an aspect of the present disclosure, a cigarette includes: a tobacco rod; a front end plug adjacent to a front end of the tobacco rod; a filter rod adjacent to a rear end of the tobacco rod; and an electromagnetic inducer located on the front end plug.

According to another aspect of the present disclosure, an aerosol generating device includes: a case; a heater for heating a cigarette including a tobacco rod, a filter rod, a front end plug adjacent to a front end of the tobacco rod, and an electromagnetic inducer located on the front end plug; a detector including a coil and detecting a change in characteristics of a current flowing through the coil generated by an electromagnetic induction action with the electromagnetic inducer as the cigarette is inserted into the case; and a controller capable of controlling operation of the heater and determining an insertion state of the cigarette based on the change in the characteristics of the current detected by the detector.

### Mode of Disclosure

With respect to the terms used to describe the various embodiments, general terms which are currently and widely used are selected in consideration of functions of structural elements in the various embodiments of the present disclosure. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and/or operation and can be implemented by hardware components or software components and combinations thereof.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Throughout the specification, the aerosol generating device may be a device that generates an aerosol using an aerosol generating material to generate an aerosol that is able to be directly inhaled into a user's lungs through the user's mouth. For example, the aerosol generating device may include a holder.

Throughout the specification, the term “puff” may refer to inhalation of the user, and the inhalation may refer to a situation in which the aerosol is pulled into the user's mouth, nasal cavity, or lungs through the user's mouth or nose.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

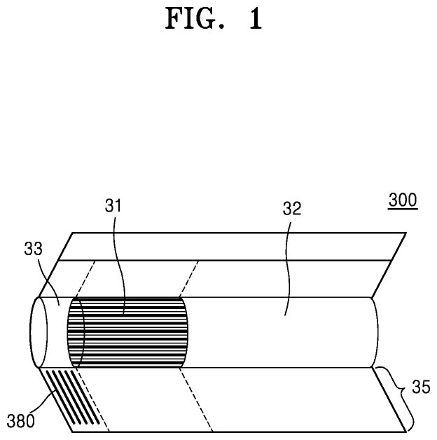

FIG. 1 is a perspective view of a cigarette according to an exemplary embodiment of the present disclosure.

Referring to FIG. 1, a cigarette 300 may include a tobacco rod 31, a filter rod 32, a front end plug 33, and an electromagnetic inducer 380 according to an exemplary embodiment of the present disclosure.

The tobacco rod 31 includes a tobacco substance and an aerosol generating material. The tobacco substance may include tobacco.

The filter rod 32 may cool an aerosol or filter a certain substance included in the aerosol.

The front end plug 33 may be arranged on one side of the tobacco rod 31 opposite the filter rod 32. The front end plug 33 may prevent the tobacco rod 31 from falling out of the cigarette 300 and also prevent the liquefied aerosol from flowing into an aerosol generating device 100 of FIGS. 1 to 3 from the tobacco rod 31 during smoking.

The cigarette 300 may be packaged by at least one wrapper 35.

The cigarette 300 may include the electromagnetic inducer 380. The electromagnetic inducer 380 may be detected through a detector 160 of the aerosol generating device 100 by electromagnetic induction.

The electromagnetic inducer 380 may include a conductor capable of inducing an eddy current, a magnetic body capable of generating a change in magnetic flux, and the like. For example, the electromagnetic inducer 380 may include a conductive metal material, magnetic ink, magnetic tape, and the like. The electromagnetic inducer 380 may include aluminium (Al) foil or graphite. In addition to that, the electromagnetic inducer 380 may include, without limitation, any substances that may be detected by causing a change in magnetic flux in a coil of the detector 160.

The electromagnetic inducer 380 may be positioned in various ways within the cigarette 300.

For example, the electromagnetic inducer 380 may be arranged in an area corresponding to the front end plug 33. Here, since the cigarette 300 is inserted into the aerosol generating device 100 in a direction in which the front end plug 33 faces the aerosol generating device 100, the electromagnetic inducer 380 may be inserted into the aerosol generating device 100 immediately after the cigarette 300 starts to be inserted into the aerosol generating device 100. The detector 160 may detect an insertion of the cigarette 300 at an early stage of insertion by detecting the approach of the electromagnetic inducer 380.

Since the front end plug 33 is separated from the aerosol generating device 100 the latest when the cigarette 300 is separated from the aerosol generating device 100, the detector 160 may detect a complete separation of the cigarette 300 by detecting a separation of the electromagnetic inducer 380.

For example, the electromagnetic inducer 380 may include metal foil. The electromagnetic inducer 380 may wrap contents of the cigarette 300 completely or partially along a circumference of the cigarette 300. The electromagnetic inducer 380 may be surrounded by the wrapper 35 in such a way that one surface of the metal foil overlaps and faces an inner surface of the wrapper 35.

A length of the electromagnetic inucer 380 extending in an axial direction of the cigarette 300 may be 6 mm to 9 mm. More specifically, the length of the electromagnetic inducer 380 in the axial direction of the cigarette 300 may be 7 mm.

For example, the electromagnetic inducer 380 may be aluminum foil and have a thickness of 6 μm to 7 μm. More specifically, the thickness of the electromagnetic inducer 380 may be 6.3 μm.

A diameter of the cigarette 300 may be within a range of 5 mm to 9 mm, and a length of the cigarette 300 may be about 48 mm. However, exemplary embodiments of the present disclosure are not limited thereto. For example, a length of the front end plug 33 may be about 7 mm, a length of the tobacco rod 31 may be about 15 mm, a length of a first segment 321 may be about 12 mm, and a length of a second segment 322 may be about 14 mm. However, embodiments of the present disclosure are not limited thereto.

For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 31 may include other additives, such as flavors, a wetting agent, and/or organic acid. Also, the tobacco rod 31 may include a flavored liquid, such as menthol or a moisturizer, which is injected to the tobacco rod 31.

The tobacco rod 31 may be manufactured in various forms. For example, the tobacco rod 31 may be formed as a sheet or a strand. Also, the tobacco rod 31 may be formed as a pipe tobacco, which is formed of tiny bits cut from a tobacco sheet. Also, the tobacco rod 31 may be surrounded by a heat conductive material. For example, the heat-conducting material may be cellulose acetate filter. Shapes of the filter rod 220 are not limited. For example, the filter rod 32 may include a cylinder-type rod or a tube-type rod having a hollow inside. Also, the filter rod 32 may include a recess-type rod. When the filter rod 32 includes a plurality of segments, at least one of the plurality of segments may have a different shape.

Shapes of the filter rod 220 are not limited.

For example, the filter rod 220 may include a cylinder-type rod or a tube-type rod having a hollow inside.

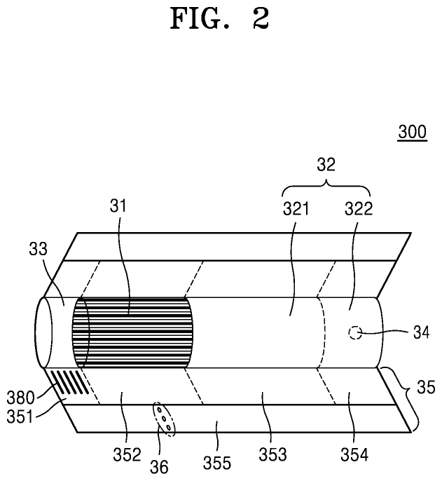

FIG. 2 is a perspective view of a cigarette according to another exemplary embodiment of the present disclosure.

The above descriptions given with reference to FIG. 1 may apply to the cigarette 300 to be described with reference to FIG. 2. Therefore, only descriptions to be added to those of the cigarette 300 of FIG. 1 will be given in FIG. 2.

The filter rod 32 may consist of a single segment or plurality of segments. For example, the filter rod 32 may include a first segment 321 configured to cool an aerosol and a second segment 322 configured to filter a certain component included in the aerosol.

The first segment 321 of the filter rod 32 may cool the aerosol generated by the heater 130 heating the tobacco rod 31. Thus, a user may inhale the aerosol cooled to a suitable temperature.

The length or diameter of the first segment 321 may differ according to a shape of the cigarette 300. For example, the length of the first segment 321 may be suitably employed within a range of 7 mm to 20 mm. It is desirable that the length of the first segment 321 be 12 mm or 14 mm. However, embodiments of the present disclosure are not limited thereto.

According to an exemplary embodiment, the first segment 321 of the filter rod 32 may include a cellulose acetate filter. In addition, the first segment 321 may be manufactured by inserting a structure, such as a film, tube, and the like of the same or different material therein (for example, in the hollow).

For example, the first segment 321 may include a tube-shaped structure including a hollow therein. When the heater 130 is inserted by the first segment 321, substances in the tobacco rod 31 may be prevented from being pushed back, and a cooling effect of the aerosol may be generated. A diameter of the hollow included in the first segment 321 may be suitably employed within a range of 2 mm to 4.5 mm. However, embodiments of the present disclosure are not limited thereto.

According to another exemplary embodiment, the first segment 321 may be made by weaving a polymer fiber. In that case, a flavored liquid may be applied onto the polymer fiber. Alternatively, the first segment 321 may be made by weaving a separate fiber onto which the flavored liquid is applied together with the polymer fiber. Alternatively, the first segment 321 may be formed by a crimped polymer sheet. Thereby, a surface area in contact with the aerosol may be increased. As a result, the cooling effect of the aerosol by a cooling structure may be further increased.

For example, the polymer may be made of a material selected from a group consisting of polyethylene (PE), polypropylene (PP), polyvinyl chloride (PVC), polyethylene terephthalate (PET), polylactide (PLA), cellulose acetate (CA), aluminum foil.

As the first segment 321 is formed by a woven polymer fiber or a crimped polymer sheet, the first segment 321 may include one or more channels extending in a longitudinal direction. The channel, here, refers to a passage through which a gas (for example, air or aerosol) passes.

The first segment 321 may include a thread containing a volatile flavor ingredient. The volatile flavor ingredient may include menthol. However, embodiments of the present disclosure are not limited thereto.

The second segment 322 of the filter rod 32 may include a cellulose acetate filter. The length of the second segment 322 may be suitably employed within a range of 4 mm to 20 mm. For example, the length of the second segment 322 may be about 14 mm or about 12 mm. However, exemplary embodiments of the present disclosure are not limited thereto.

The second segment 322 may be made of cellulose acetate.

The second segment 322 may be made by spraying the flavored liquid onto the second segment 322 for a flavor to be produced. Alternatively, a separate fiber onto which the flavored liquid is applied may be inserted into the second segment 322. The aerosol generated from the tobacco rod 31 is cooled while passing through the first segment 321, and the cooled aerosol is delivered to the user through the second segment 322. Therefore, when a flavoring element is added to the second segment 322, the flavor delivered to the user may last for a long time.

Hereinafter, the wrapper 35 will be described in detail.

The wrapper 35 may include a plurality of wrappers which respectively surround the segments.

For example, the front end plug 33 may be packaged by a first wrapper 351, the tobacco rod 31 may be packaged by a second wrapper 352, the first segment 321 may be packaged by a third wrapper 353, and the second segment 322 may be packaged by a fourth wrapper 354. Finally, the cigarette 300 may be completely repackaged by a fifth wrapper 355.

The first wrapper 351 may include metal foil, such as aluminum foil combined with common plug wrap paper.

The second wrapper 352 and the third wrapper 353 may be made of plug wrap paper. For example, the second wrapper 352 and the third wrapper 353 may include a porous wrapper or a non-porous wrapper.

At least one perforation 36 may be formed in the wrapper 35. External air may flow into the cigarette 300 through the perforations 36 formed in the wrapper 35.

The number of the perforations 36 may differ from 3 to 10, and the like, and the perforations 36 may be spaced apart from each other at a constant distance, or may be spaced apart from each other at different distances with a pattern.

The electromagnetic inducer 380 may be surrounded by the first wrapper 351 in such a way that one surface of the metal foil is overlapped while facing an inner surface of the first wrapper 351. According to another exemplary embodiment, the metal foil of the electromagnetic inducer 380 may surround the cigarette 300 while overlapping between the first wrapper 351 and the fifth wrapper 355. The electromagnetic inducer 380 may be prevented from being damaged by foreign materials, due to the wrapper 35.

The electromagnetic inducer 380 may have one end contacting the first wrapper 351 surrounding the front end plug 33 and the other end contacting the second wrapper 352 surrounding the tobacco rod 31. Alternatively, the other end of the electromagnetic inducer 380 may contact the third wrapper 353 surrounding the filter rod 32.

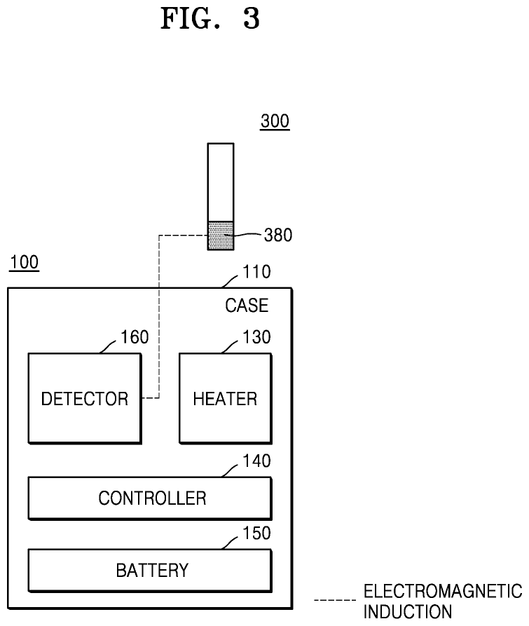

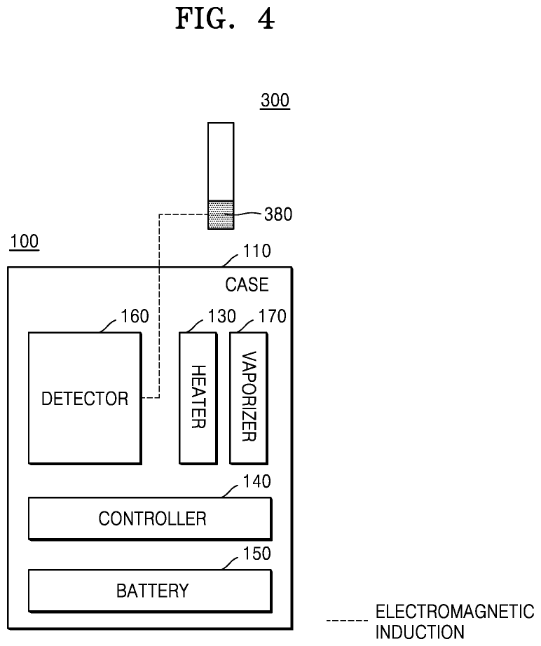

FIGS. 3 and 4 are block diagrams illustrating exemplary embodiments of an aerosol generating device.

Referring to FIG. 3, the aerosol generating device 100 may include a case 110, the heater 130, the detector 160, a battery 150, and a controller 140. The cigarette 300 may include the electromagnetic inducer 380. The cigarette 300 may be inserted into an interior space of the aerosol generating device 100.

FIGS. 3 and 4 illustrate components of the aerosol generating device 100, which are related to the present exemplary embodiment. Therefore, it will be understood by one of ordinary skill in the art related to the present exemplary embodiment that other general-purpose components may be further included in the aerosol generating device 100, in addition to the components illustrated in FIGS. 3 and 4.

FIG. 3 illustrates that the battery 150, the controller 140, and the heater 130 are arranged in series. Also, FIG. 3 illustrates that the battery 150, the controller 140, the vaporizer 170, and the heater 130 are arranged in series. Also, FIG. 4 illustrates that the vaporizer 170 and the heater 130 are arranged in parallel. However, the internal structure of the aerosol generating device 100 is not limited to the structures illustrated in FIGS. 3 and 4. In other words, according to the design of the aerosol generating device 100, the battery 150, the controller 140, the heater 130, and the vaporizer 170 may be differently arranged.

When the cigarette 300 is inserted into the aerosol generating device 100, the aerosol generating device 100 may operate the heater 130 and/or the vaporizer 170 to generate an aerosol from the cigarette 300 and/or the vaporizer 170. The aerosol generated by the heater 130 and/or the vaporizer 170 is delivered to a user by passing through the cigarette 300.

As necessary, even when the cigarette 300 is not inserted into the aerosol generating device 100, the aerosol generating device 100 may heat the heater 130.

The case 110 forms a portion of an exterior of the aerosol generating device 100, and accommodates and protects various components therein.

The heater 130 is heated by electric power supplied by the battery 150, and thereby may heat and vaporize an aerosol generating material. However, the heater 130 is not limited to the example described above and may include any heaters which may be heated to a desired temperature. Here, the desired temperature may be pre-set in the aerosol generating device 100 or may be set by a user.

When the cigarette 300 is inserted into the aerosol generating device 100, the heater 130 may be arranged inside or outside of the cigarette 300 to heat the aerosol generating material.

The heater 130 may include an electro-resistive heater. For example, the heater 130 may include an electrically conductive track, and the heater 130 may be heated when currents flow through the electrically conductive track.

As another example, the heater 130 may include an induction heater. In detail, the heater 130 may include an electrically conductive coil 260 for heating a cigarette by an induction heating method, and the cigarette 300 may include a susceptor which may be heated by the induction heater.

The shape of the heater 130 may be manufactured in various shapes. For example, the heater 130 may include a tube-type heating element, a plate-type heating element, a needle-type heating element, or a rod-type heating element. The heater 130 may heat the inside or the outside of the cigarette 300, according to the shape of the heating element.

Although one heater 130 is illustrated in FIGS. 3 and 4, embodiments are not limited thereto. For example, a plurality of heater 130 may be disposed in the aerosol generating device 100. When the aerosol-generating material is provided in the cigarette 300, the plurality of heater 130 may be disposed to be inserted into the cigarette 300, or may be disposed outside the cigarette 300. Alternatively, some of the plurality of heater 130 may be disposed to be inserted into the cigarette 300, and the rest may be disposed outside the cigarette 300.

The detector 160 may detect an insertion state in the aerosol generating device 100 of the cigarette 300. The detector 160 may include a coil. As the cigarette 300 is inserted into or separated from the case 110, electromagnetic induction may occur between the coil and the electromagnetic inducer 380. In that case, the detector 160 may detect a change in characteristics of a current flowing through the coil generated by the electromagnetic induction.

A single detector 160 has been illustrated in FIGS. 3 and 4. However, two or more detectors 160 may be arranged according to an exemplary embodiment of the present disclosure.

The detectors 160 may detect an insertion state of the cigarette 300 from different positions. A plurality of detectors 160 may be spaced apart from each other in a vertical direction.

Eddy current may be induced by the detector 160 and may flow within the electromagnetic inducer 380. The detector 160 may detect the eddy current induced in the coil of the detector 160 by the electromagnetic inducer 380.

The detector 160 may detect the change of various current characteristics using electromagnetic induction. For example, the current characteristics may include a current value of a current flowing through a coil, a frequency value in the case of an alternating current, magnitude of a voltage, an inductance value of a coil that is changed by a current according to mutual induction, a quality factor of a coil, effective resistance, an impedance value, and the like. To this end, the detector 160 including the detector 160 may further include a frequency measuring device, a rectifier, an amplifier, an oscillation circuit that generates electrical vibration, and the like.

The detector 160 may detect changes in the characteristics of the current flowing through the coil due to the electromagnetic induction in various ways. According to an exemplary embodiment, an alternating current may be applied to the coil, and the alternating current may induce an eddy current within the electromagnetic inducer 380. The eddy current flowing through the electromagnetic inducer 380 may induce a change in the current flowing through the coil again through mutual induction with the coil. The detector 160 including the detector 160 may detect such change in the current flowing through the coil.

According to another exemplary embodiment, the detector 160 may include a transmitting coil through which an alternating current flows, and induces an eddy current within the electromagnetic inducer 380 and a detecting coil that detects the eddy current flowing through the electromagnetic inducer 380. In that case, the transmitting coil and the detecting coil may be arranged in a vertical direction, thus interference between the transmitting coil and the detecting coil can be minimized. The detector 160 may detect mutual induction between the coil and the electromagnetic inducer 380 in various ways. However, embodiments of the present disclosure are not limited thereto.

The fact that the detector 160 detects changes in the current characteristics due to the electromagnetic induction may include not only directly measuring the current using an ammeter, but also indirectly detecting the current. For example, those skilled in the art may understand that the detector 160 may detect a current change by measuring induced electromotive force induced in the coil in the form of a voltage.

Referring to FIG. 4, an aerosol generating device may further include a vaporizer.

The vaporizer 170 may generate an aerosol by heating a liquid composition and the generated aerosol may pass through the cigarette 300 to be delivered to a user. In other words, the aerosol generated via the vaporizer 170 may move along an air flow passage of the aerosol generating device 100 and the air flow passage may be configured such that the aerosol generated via the vaporizer 170 passes through the cigarette 300 to be delivered to the user. The vaporizer 170 may generate an aerosol by heating a liquid composition, and discharges the aerosol toward the cigarette 300 so that the aerosol passes through the cigarette 300 inserted into the cigarette accommodation space.

For example, the vaporizer 170 may include a liquid storage, a liquid delivery element, and a heating element, but it is not limited thereto. For example, the liquid storage, the liquid delivery element, and the heating element may be included in the aerosol generating device 100 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detached from the vaporizer 170 or may be formed integrally with the vaporizer 170.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 170 may be referred to as a cartomizer or an atomizer, but it is not limited thereto.

The battery 150 may supply power to be used for the aerosol generating device 100 to operate. For example, the battery 150 may supply power to heat the heater 130 or may supply power for operating the controller 120. The battery 150 may supply power so that the detector 160 can operate. Also, the battery 150 may supply power for operations of a display, a sensor, a motor, etc. mounted in the aerosol generating device 100.

According to an exemplary embodiment, the battery 150 may be electrically connected to the adapter, and the DC output from the battery 150 may be converted into an AC current and output to the adapter.

The controller 140 controls overall operations of the aerosol generating device 100. More specifically, the controller 140 controls not only the battery 150, the heater 130, and the detector 160, but also other components included within the aerosol generating device 100.

The controller 140 may control operation of the detector 160. The controller 140 may regulate a frequency of the alternating current applied to the detector 160, a magnitude of the current, and the like.

The controller 140 may determine whether the electromagnetic inducer 380 is approaching the coil, based on a change in the current flowing through the coil detected by the detector 160. In other words, the controller 140 may determine whether a cover 120 including the electromagnetic inducer 380 is coupled to or separated from the case 110.

The controller 140 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The aerosol generating device 100 may further include general-purpose components in addition to the battery 150, the heater 130, the detector 160 and the controller 140. For example, the aerosol generating device 100 may include a display capable of outputting visual information and/or a motor for outputting tactile information, a charging terminal for charging the battery 150, and the like. The motor may inform, for example, that the heating of the heater 130 is completed through vibration. For example, the aerosol-generating device 100 includes an LED, and may display an operating state of the heater 130 through the LED.

The aerosol generating device 100 and an additional cradle (not shown) may form together a system. For example, the cradle may be used to charge the battery 150 of the aerosol generating device 100. Alternatively, the heater 130 may be heated when the cradle and the aerosol generating device 100 are coupled to each other.

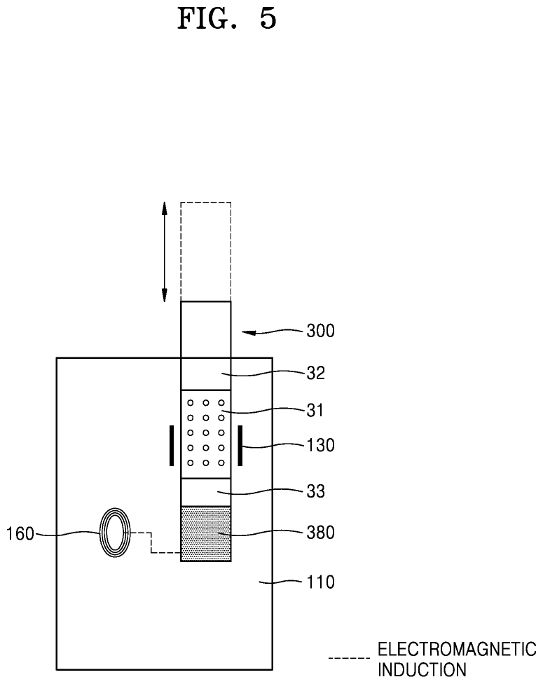

FIG. 5 is a diagram illustrating an aerosol generating device into which a cigarette is inserted.

Referring to FIG. 5, when the cigarette 300 is inserted into a case, the tobacco rod 31 may be arranged alongside the heater 130, and the front end plug 300 may be arranged alongside the detector 160. The tobacco rod 31 may be surrounded and heated by the heater 130, and the front end plug 33 may approach the detector 160.

As the cigarette 300 is inserted into the case 110, a distance between the electromagnetic inducer 380 and the detector 160 may be reduced. The detector 160 may detect a change in the characteristics of a current flowing through a coil, which is generated as the electromagnetic inducer 380 approaches. The controller 140 may determine that the cigarette 300 is inserted into the case 110, based on the detected change in the characteristics of the current.

By contrast, as the cigarette 300 is separated from the case 110, the distance between the electromagnetic inducer 380 and the detector 160 may increase, and the detector 160 may detect a change in the characteristics of the current flowing through the coil, accordingly. The controller 140 may determine that the cigarette 300 is separated from the case 110, based on the detected change in the characteristics of the current.

The aerosol generating device 100 may identify a type of the cigarette 300 inserted into the case 110. Depending on a length, position, shape, and the like of the electromagnetic inducer 380, a current characteristic value detected by the detector 160 through the electromagnetic inducer 380 may differ. Based on the current characteristic value received from the detector 160, the controller 140 may identify a type of the cigarette 300 based on the length, position, shape, and the like of the electromagnetic inducer 380.

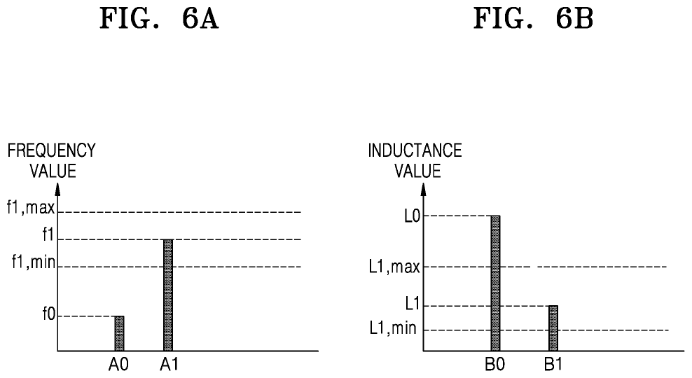

FIGS. 6 is graph of characteristics of a current detected by an aerosol generating device based on an insertion state of a cigarette.

Referring to FIG. 6, a frequency value and an inductance value of a coil among various current characteristic values that may be detected by the aerosol generating device 100 are shown as an example. The following descriptions are not limited to the frequency value and the inductance value, and they may apply to other current characteristic value in that a change in the current characteristic value is compared with a reference value.

Current characteristic values may indicate physical quantities that may be converted to each other through calculation. For example, the frequency value may be detected through Equation 1 to obtain the inductance value of the coil through calculation. Therefore, measuring one current characteristic value also includes measuring other current characteristic value that may be obtained from the measured current characteristic value.

$$L = \frac{1}{{( 2 π * Fsen )}^{C}} \qquad [ Equation 1 ]$$

Inductance L of the coil may be obtained by Equation 1. Fsen refers to the frequency of the current flowing through the coil, and C refers to capacitance of the coil. The capacitance C of the coil may reflect the capacitance of the coil itself and parasitic capacitance.

Referring to FIG. 6A, the controller 140 may preset a minimum frequency reference value (f1, min) and a maximum frequency reference value (f1, max). When a frequency value of a signal measured by the detector 160 is greater than or equal to the minimum frequency reference value (f1, min) and less than the maximum frequency reference value (f1, max), the controller 140 may recognize that the cigarette 300 is in an insertion state or a specific type of the cigarette 300 is inserted.

For example, when the detector 160 detects a signal A0, since a frequency vale f0 is less than the minimum frequency reference value (f1, min), the controller 140 may determine that the cigarette 300 is not inserted.

The minimum frequency reference value (f1, min) and the maximum frequency reference value (f1, max) may be set in consideration of a basic signal generated by the current applied to the coil by the controller 140 being affected by a metal material of the case 110 itself and the like. Since the basic signal may continuously affect the detector 160 regardless of an insertion state of the cigarette 300, the controller 140 may identify an insertion state of the cigarette 300 and types of the inserted cigarette 300, considering the effect of the basic signal.

The minimum frequency reference value (f1, min) may be set greater than or equal to the frequency of the basic signal, and less than the frequency of a signal detected when the cigarette 300 is inserted.

In the example described above, the frequency value of the signal detected when the cigarette 300 is inserted is greater than the frequency value of the basic signal. However, according to another exemplary embodiment, depending on a shape and layout of the detector 160 and a shape and layout of the electromagnetic inducer 380, the frequency value of the signal measured when the cigarette 300 is inserted may be less than the frequency value of the basic signal.

Referring to FIG. 6B, the controller 140 may preset a minimum inductance reference value (L1, min) and a maximum inductance reference value (L1, max).

The inductance value may be obtained from the frequency value through calculation. The inductance value may change according to an approach of the electromagnetic inducer 380, and the inductance value may tend to change to the opposite to the change of the frequency value. For example, when the electromagnetic inducer 380 approaches, the inductance value may decrease whereas the frequency value may increase.

When an inductance value L1 of the coil that changes according to a signal B1 measured by the detector 160 is greater than or equal to the minimum inductance reference value (L1, min) and less than the maximum inductance reference value (L1, max), the controller 140 may recognize that the cigarette 300 is in an insertion state or a specific type of the cigarette 300 is inserted.

In addition, when the detector 160 detects a signal B0, since an inductance value L0 that changes according to the signal B0 is greater than or equal to the maximum inductance reference value (L1, max), the controller 140 may determine that the cigarette 300 is not inserted.

The minimum inductance reference value (L1, min) and the maximum inductance reference value (L1, max) may be set in consideration of a basic signal generated by the current applied to the coil by the controller 140 being affected by a metal material of the case 110 itself and the like.

Unlike the example described above, depending on a shape and layout of the detector 160 and a shape and layout of the electromagnetic inducer 380, the inductance value may increase according to an approach of the electromagnetic inducer 380.

The descriptions of the above-described exemplary embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

What is claimed is:

1. A cigarette comprising:
a tobacco rod;
a front end plug disposed at a front end of the tobacco rod;
a filter rod disposed at a rear end of the tobacco rod; and
an electromagnetic inducer provided in the front end plug.

2. The cigarette of claim 1, wherein the electromagnetic inducer is a thin film surrounding at least a portion of the front end plug.

3. The cigarette of claim 1, further comprising a wrapper surrounding the front end plug,
wherein the electromagnetic inducer is a thin film of which one surface overlaps and faces an inner surface of the wrapper.

4. The cigarette of claim 1, further comprising a first wrapper surrounding the front end plug and a fifth wrapper surrounding the first wrapper,
wherein the electromagnetic inducer is a thin film arranged between the first wrapper and the fifth wrapper.

5. The cigarette of claim 1, wherein the electromagnetic inducer includes at least one of conductive metal, magnetic ink, and magnetic tape.

6. The cigarette of claim 1, wherein the electromagnetic inducer includes at least one of aluminum (A) and graphite.

7. The cigarette of claim 1, wherein the electromagnetic inducer has a length of 6 mm or greater and less than 9 mm in a lengthwise direction of the cigarette.

8. The cigarette of claim 1, wherein the electromagnetic inducer is a thin metal film having a thickness of 6 μm or greater and less than 7 μm.

9. The cigarette of claim 1, wherein, when the cigarette is inserted into an aerosol generating device, the tobacco rod is surrounded by a heater capable of heating the tobacco rod, and the front end plug is positioned adjacent to a detector including a coil capable of detecting the electromagnetic inducer.

10. An aerosol generating device comprising:
a case;
a heater configured to heat a cigarette including a tobacco rod, a filter rod, a front end plug disposed at a front end of the tobacco rod, and an electromagnetic inducer provided in the front end plug;
a detector including a coil and configured to detect a change in characteristics of a current flowing through the coil which is generated according to electromagnetic induction caused by the electromagnetic inducer as the cigarette is inserted into the case; and
a controller configured to control the heater and determine an insertion state of the cigarette based on the change in the characteristics of the current detected by the detector.

11. The aerosol generating device of claim 10, further comprising a vaporizer configured to vaporize a liquid composition to generate an aerosol and deliver the aerosol into the cigarette through the front end plug.
